(19) United States
(12) Patent Application Publication
(10) Pub. No.: US 2019/0119526 A1
(43) Pub. Date: Apr. 25, 2019

(54) POLISHING LIQUID FOR GLASS, AND POLISHING METHOD

(71) Applicant: PANASONIC INTELLECTUAL PROPERTY MANAGEMENT CO., LTD., Osaka (JP)

(72) Inventors: Haruka NISHIKAWA, Aichi (JP); Toshiyuki IEDA, Ishikawa (JP); Atsushi NAGAI, Osaka (JP); Kazuya SHIMADA, Aichi (JP)

(73) Assignee: PANASONIC INTELLECTUAL PROPERTY MANAGEMENT CO., LTD., Osaka (JP)

(21) Appl. No.: 16/093,061

(22) PCT Filed: Sep. 22, 2017
(86) PCT No.: PCT/JP2017/034252

§ 371 Date: Oct. 11, 2018

(30) Foreign Application Priority Data
Sep. 30, 2016 (JP) 2016-194959

(51) Int. Cl. C09G 1/04; C03C 15/00

(52) U.S. Cl. CPC C09G 1/04; C03C 15/00

(57) ABSTRACT

An occurrence of a dimple during glass polishing is suppressed by scraping a fine scratch that will become the dimple to be grown in a pre-polishing, followed by main polishing. However, at a mark of the dimple in which the growth thereof is suppressed in the pre-polishing, fine roughening of a surface is generated. Further, a polishing liquid containing hydrofluoric acid, an alkali metal, water, and a surfactant that is a sulfonic acid-type or sulfate-type surfactant can suppress excess crystal growth of a deposit formed in a fine scratch in pre-polishing and suppress roughening of a surface after polishing.

### FIELD

The present invention relates to a polishing liquid for polishing glass of a liquid crystal screen or an organic EL screen used in a portable electronic appliance, a flat panel display (FPD), or the like.

### BACKGROUND

A flat display device such as a liquid crystal display device and an organic EL display device has been often used for products such as a mobile phone, a smartphone, a tablet computer, and a laptop personal computer. In the flat display device, glass is mainly used as a base material. Hereinafter, the display device is referred to as a “glass-made display device.”

In the glass-made display device, a driving portion such as a liquid crystal, TFT, and a light-emitting layer is formed between two glass plates that serve as a base material. During the formation of the driving portion, the glass plates are required to have such strength that the glass is not broken in handling. Therefore, as a material for the glass, alkali-free glass in which boric acid and alumina are contained, such as aluminoborosilicate glass, is used, but not soda glass used for window glass or the like. Furthermore, the glass used should have a certain thickness.

However, after the glass having a certain thickness is formed into a form of the glass-made display device, it is inconvenient to convey such glass that is heavy. Therefore, after the driving portion is formed in the glass, the glass is polished with an etchant for glass to decrease the thickness of the glass.

A problem in polishing is that a recess (hereinafter referred to as “dimple”) is formed in the glass after polishing. The dimple is a recess having a diameter of several micrometers to several hundreds micrometers and a depth of several micrometers to several tens micrometers. The dimple on the display device may be remarkable depending on an image. This may be a problem in terms of product quality. Accordingly, one technical problem in glass polishing is to suppress the dimple after polishing.

In order to prevent a pit or scratch having a size of about 10 μm from increasing to a size of 100 μm or more by polishing, Patent Literature 1 discloses a technique for polishing glass at a polishing rate of 1 μm/sec or more with a polishing liquid containing 30 to 60% by weight of hydrofluoric acid as a polishing component and one or two or more types of additives selected from inorganic acids such as hydrochloric acid, sulfuric acid, nitric acid, and phosphoric acid and surfactants such as ester-based, phenolic, amide-based, ether-based, nonionic, and amine-based surfactants.

Patent Literature 2 discloses a method in which a glass substrate is treated with etchants having etching rates in an order of decreasing the etching rate to suppress occurrence of a pit.

Patent Literature 3 discloses a method including filling micropore portions with a liquid inert to an etchant and etching a surface so that the surface is etched while a scratch on the surface is prevented from increasing. It is considered that the liquid inert to the etchant is suitably a perfluoroalkyl compound.

Patent Literature 4 discloses pre-polishing using 0.4 to 4% by weight of hydrofluoric acid and 40 to 90% by weight of sulfuric acid and post-polishing using 2 to 30% by weight of hydrofluoric acid. Herein, a mechanism of suppressing growing of a dimple is estimated as follows. The dimple is brought into contact with a high-viscosity polishing liquid containing an appropriate concentration of hydrofluoric acid, so that a fluoride is deposited in a micro crack to enclose the dimple. In this case, a flat portion would be first polished, and the crack would be eliminated.

### CITATION LIST

### Patent Literature

Patent Literature 1: Japanese Patent Application Laid-Open No. 2003-226552

Patent Literature 2: Japanese Patent Application Laid-Open No. 2004-077640

Patent Literature 3: Japanese Patent Application Laid-Open No. 2005-011894

Patent Literature 4: Japanese Patent Application Laid-Open No. 2007-297228

### SUMMARY

### Technical Problem

The occurrence of such a dimple is suppressed by scraping a fine scratch that will become the dimple to be grown in a pre-polishing step, followed by main polishing. However, at a mark of the dimple in which the growth is suppressed in the pre-polishing step, fine roughening of a surface is generated. This roughened surface does not necessarily decrease the quality of a product, but may decrease the grade of the product.

### Solution to Problem

The present invention has been conceived in view of the problems. A cause of roughening a surface has been examined in detail, and a method for suppressing the cause has been intensively studied. As a result, the present invention has been completed. Accordingly, the present invention provides a polishing liquid used in a pre-polishing step and a polishing method using the same.

More specifically, the polishing liquid according to the present invention contains hydrofluoric acid, an alkali metal, water, and a surfactant, wherein the surfactant is a sulfonic acid-type or sulfate-type surfactant.

The polishing method according to the present invention includes the steps of:

treating a substance to be treated having a glass surface with a polishing liquid containing hydrofluoric acid, an alkali metal, water, and a sulfonic acid-type or sulfate-type surfactant; and

treating the substance with the polishing liquid containing hydrofluoric acid and water.

### Advantageous Effects of Invention

Due to a roughened surface, a deposit is temporarily accumulated on a fine scratch portion, which will become a dimple, in a pre-polishing step using a polishing liquid containing an alkali metal, and the deposit then grows by crystal growth and is attached also to a glass flat portion near the scratch. Accordingly, the polishing rate at the portion where the deposit is attached decreases as compared with the polishing rate at grass surrounding the portion. This phenomenon is considered to forma crater-shaped protrusion on a glass surface. The polishing liquid according to the present invention causes the deposit to be accumulated in the scratch, which will become the dimple, due to an effect of a surfactant, but can suppress crystal growth of the deposit on the glass flat portion near the scratch. Therefore, a glass surface that is hardly roughened can be obtained.

### BRIEF DESCRIPTION OF DRAWINGS

FIG. 1 is a view illustrating states of glass polishing.

FIG. 2 is photographs of a crater-shaped protrusion formed after pre-polishing and a roughened surface formed after main polishing.

FIG. 3 is a graph and a photograph showing a result in which the crater-shaped protrusion is measured by a step height measurement device.

FIG. 4 is a view illustrating an evaluation method in Examples.

FIG. 5 is a graph showing a result of polishing amount measured as an effect of a surfactant according to the present invention.

FIG. 6 is a photograph showing the effect of the surfactant according to the present invention.

### DESCRIPTION OF EMBODIMENTS

Hereinafter, the polishing liquid and polishing method according to the present invention will be described by using the drawings. The following description is a description of one embodiment of the present invention, and the present invention is not limited to the following description. In other words, the following embodiment can be modified without departing from the spirit of the present invention.

When polishing of a glass-made display device is performed by dividing into pre-polishing and post-polishing, the polishing liquid according to the present invention is used in the pre-polishing. A subject to be polished is glass usable in the glass-made display device. Oxide glass containing an oxide as a main component can be suitably used. In particular, glass containing aluminosilicate glass (alumina and silicon oxide) as a main component is preferable. Aluminosilicate glass is preferable as a base material of the glass-made display device since it has high tensile strength.

When the type of element to be added to the aluminosilicate glass is changed, the composition of glass can be changed. The aluminosilicate glass to which boron (B) is further added as a main component and magnesium (Mg), calcium (Ca), strontium (Sr), and barium (Ba) are added as auxiliary components is referred to as aluminoborosilicate glass. The aluminoborosilicate glass is particularly suitably used as the base material of the glass-made display device.

Glass is handled in the form of a glass plate. This is because the glass is used as the base material of the glass-made display device. Therefore, glass that cannot be supplied as a glass plate, such as an insulating film of a semiconductor, is not an object to be used in polishing.

<Roughening of Surface>

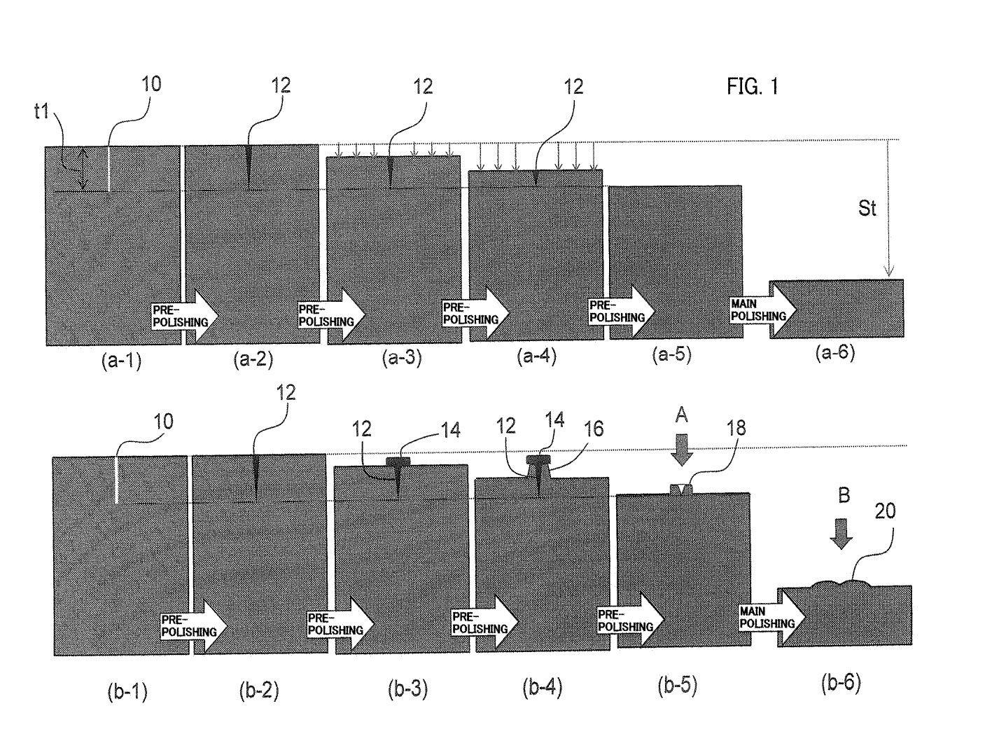

FIG. 1 schematically illustrates a phenomenon of conventional glass polishing. FIGS. 1(a-1) to 1(a-6) illustrate a case where ideal pre-polishing is performed and a surface is not roughened. In contrast, FIGS. 1(b-1) to 1(b-6) illustrate a case where a surface is roughened.

Reference is made to FIGS. 1(a-1) to 1(a-6). It is considered that a fine scratch 10 is present on a surface of glass before a treatment due to conveyance and the like (FIG. 1(a-1)). The pre-polishing means that the glass is removed by a thickness t1 in which the scratch 10 is present in advance for main polishing.

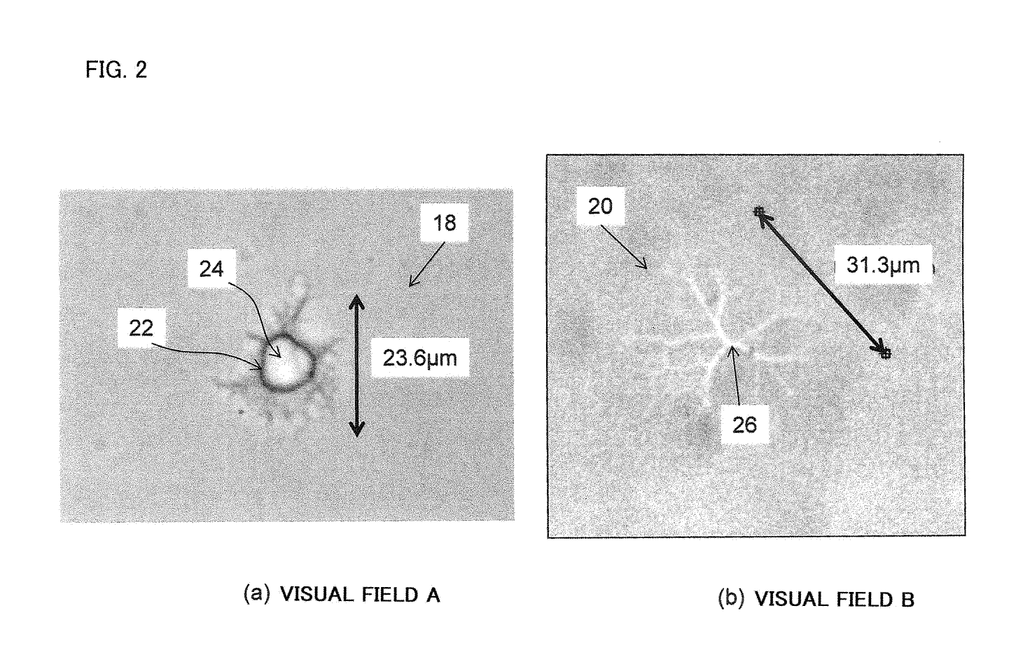

When pre-polishing is started, the fine scratch 10 is filled with a deposit 12 produced by polishing (FIG. 1(a-2)). The deposit 12 inhibits an etching reaction of the scratch, but etching proceeds at a flat portion including no deposit (FIGS. 1(a-3) and 1(a-4)). When pre-polishing is terminated, the entire of the fine scratch 10 is eliminated (FIG. 1(a-5)). Subsequently, main polishing is performed to polish the surface of the glass by only a predetermined thickness (FIG. 1(a-6)). The polishing amount in pre-polishing is about 10 to 40 μm and the final polishing amount St is several hundreds micrometers.

Conventionally, a component having very high acidity such as sulfuric acid is added to a polishing liquid, to remove the fine scratch 10 without growing. However, addition of an alkali metal instead of a strong acid can suppress the growth of such a scratch 10

Next, reference is made to FIGS. 1(b-1) to 1(b-6). A fine scratch 10 is present on a surface of glass before a treatment (FIG. 1(b-1)). When pre-polishing is started, a deposit 12 is formed on the fine scratch 10, similarly to the case illustrated in FIG. 1(a-2). In FIG. 1(b-3), a deposit 14 is further formed on the deposit 12 due to crystal growth of the deposit 12. The deposit 14 grows also on a glass flat portion, and the polishing rate on the glass under the deposit 14 decreases. As a result, a convex undulation 16 is formed around the deposit 12 (FIG. 1(b-4)).

The deposits 12 and 14 in the center of the convex undulation 16 are finally removed by pre-polishing. However, a crater-shaped protrusion 18 formed by removing the deposits 12 and 14 from the convex undulation 16 remains on the glass surface (FIG. 1(b-5)). When main polishing is started, the crater-shaped protrusion 18 is removed in some extent. However, a gentle undulation 20 remains on the glass surface. The gentle undulation 20 is observed as roughening of the surface.

The deposit 14 formed on the deposit 12 as described above is observed when the polishing liquid contains an alkali metal. In other words, when the alkali metal is added to the polishing liquid, the growth of the scratch 10 is suppressed, but a roughened surface (gentle undulation 20) may finally remain.

FIG. 2 shows micrographs as viewed in directions A and B of FIGS. 1(b-5) and 1(b-6), respectively. FIG. 2(a) shows the crater-shaped protrusion 18 in FIG. 1(b-5). FIG. 2(b) shows the roughened surface (gentle undulation 20) in FIG. 1(b-6). In the crater-shaped protrusion 18 in FIG. 2(a), an annular rim 22 and a basin 24 are clearly observed. The length of the crater-shaped protrusion 18 including a skirt is 23.6 μm.

The roughened surface in FIG. 2(b-6) is observed on the glass surface by white in a crack pattern 26. The length of the roughened surface (gentle undulation 20) is 31.3 μm.

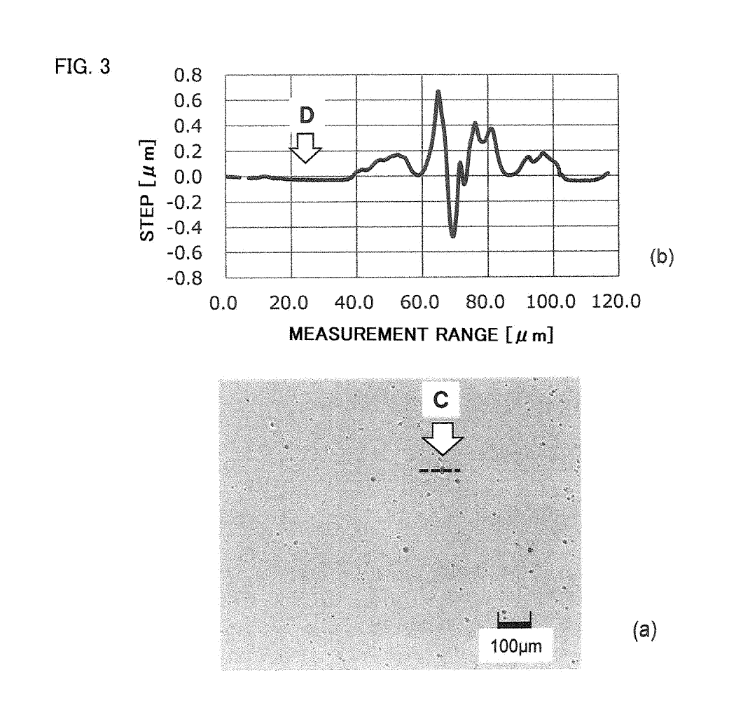

FIG. 3 shows observation of the roughened surface (gentle undulation 20) portion by a microscope and a result of measurement of step height of the portion. FIG. 3(a) is a micrograph and FIG. 3(b) is the result of step height measurement. In the step height measurement, P6 manufactured by KLA-Tencor Japan Ltd. was used.

Reference is made to FIG. 3(a). The length of a black line in FIG. 3(a) corresponds to 100 μm. The roughened surface (gentle undulation 20) is a portion shown by an arrow C in FIG. 3(a). FIG. 3(b) illustrates the result of step height measurement along a dotted line at the portion shown by the arrow C.

Next, reference is made to FIG. 3(b). The horizontal axis represents a measurement range (μm) and the vertical axis represents a height (μm). As seen from FIG. 3(b), the roughened surface (gentle undulation 20) portion has a peak-to-peak height of about 1.2 μm, and a convex shape with a height of about 0.6 μm from the glass surface (portion shown by an arrow D) is formed. A portion corresponding to the surface of the arrow D is very smooth. When a treatment is performed with the polishing liquid according to the present invention as described in the following Examples, roughening of the surface can be suppressed so that such a roughened surface (gentle undulation 20) can hardly be found.

<Polishing Liquid>

The polishing liquid according to the present invention contains hydrofluoric acid, an alkali metal, water, and a surfactant. The concentration of hydrofluoric acid relative to the whole amount of the polishing liquid may be about 1 to 10% by mass, preferably 1 to 8% by mass, and more preferably 1 to 5% by mass. When the concentration is too high, uniform polishing is unlikely to be archived. When it is too low, glass cannot be polished.

As the alkali metal, sodium (Na) or potassium (K) can be suitably used. The alkali metal in a salt form is added to form an ion in the polishing liquid. The concentration of alkali metal (considered as the ion form) relative to the whole amount of the polishing liquid may be 0.1 to 2.0 mol/L, preferably 0.2 to 1.5 mol/L, and more preferably 0.3 to 1.0 mol/L.

The surfactant acts to prevent the formation of the deposit 14 (see FIG. 1) on the deposit 12 (see FIG. 1) formed in the fine scratch 10 (see FIG. 1) in the glass surface. In order to obtain such an action, a substance that is present in an anionic form in the polishing liquid can be suitably used. The polishing liquid is a solution having very low pH. Therefore, a substance that is present in an anionic form also in such a liquid needs to have a small acid dissociation constant (pKa). This is because in a solution having low pH, a substance having a large acid dissociation constant incorporates hydrogen ions in the solution, resulting in the substance in a nonionic form.

It is considered that a surfactant having a small acid dissociation constant is a salt containing a functional group having a small acid dissociation constant. The surfactant having a small acid dissociation constant is a sulfonic acid-type surfactant having a sulfonic acid group or a sulfate-type surfactant having a sulfonic acid ester group. The inventors of the present invention have confirmed that the sulfonic acid-type or sulfate-type surfactant can be suitably used.

Herein, the sulfonic acid-type surfactant is a surfactant having a sulfonic acid group (—SO₃M) in the skeleton. “M” is a paired cation for forming a salt, and is specifically exemplified below. The sulfate-type surfactant is a surfactant having a sulfonic acid ester group (—O-SO₃M) in the skeleton.

More specifically, examples of the “sulfonic acid-type” surfactant may include an alkane sulfonic acid salt, an alkyl amide sulfonic acid salt, an alkyl ether sulfosuccinic acid salt, an alkyl diphenyl ether disulfonic acid salt, an alkyl (branched chain) benzene sulfonic acid salt, an alkylene disulfonic acid salt, a linear alkylbenzene sulfonic acid salt, a phenol sulfonic acid salt, a polyoxyethylene alkyl ether sulfosuccinic acid salt, a polyoxyethylene alkylphenyl ether sulfonic acid salt, a polyoxyethylene alkyl sulfosuccinic acid disalt, a polystyrene sulfonic acid salt, a monoalkyl sulfosuccinic acid salt, a monoalkyl sulfosuccinic acid disalt, an alkylnaphthalene sulfonic acid salt, a dialkylsulfosuccinic acid salt, a fatty acid alkylol alkylbenzene sulfonic acid salt, an N-acyl taurine acid salt, a naphthalene sulfonic acid formalin condensate salt, an α-olefin sulfonic acid salt, and an α-sulfo fatty acid ester salt.

Examples of the sulfate-type surfactant may include an alkyl ether sulfuric acid salt, an alkenyl sulfuric acid ester salt, an alkyl polyoxyethylene sulfuric acid salt, a polyoxyethylene alkyl aryl sulfuric acid ester salt, a polyoxyethylene alkyl ether sulfuric acid ester salt, a polyoxyethylene alkyl phenyl ether sulfuric acid ester salt, an oil-and-fat sulfuric acid ester salt, a higher alkyl ether sulfuric acid ester salt, an alkyl sulfuric acid ester salt, and a higher alcohol sulfuric acid ester salt.

Incidentally, as a paired ion when these substances become salts, the following can be mentioned.

Sodium, potassium, lithium, magnesium, ammonium, monoethanol ammonium, diethanol ammonium, triethanol ammonium, tetrabutyl ammonium and the like can be suitably used.

### EXAMPLES

<Evaluation Method>

Roughening of a surface (gentle undulation 20) (see FIG. 1) of glass is discriminated with unaided eye by a microscope, but judgment using a photograph is very difficult. For example, it cannot be said that judgement using photographs of FIGS. 2(b) and 3(a) is easy. This is because a contrast between a portion of roughened surface (gentle undulation 20) and a background is unlikely to be confirmed.

For quantification of roughening of the surface (gentle undulation 20), the polishing amount relative to a polishing liquid having a certain concentration was measured. As shown in FIG. 3, the roughened surface portion (gentle undulation 20) is protruded from a glass surface (protrusion). Therefore, the glass in which the surface is roughened (gentle undulation 20) is observed to be thicker by the thickness of the protruded portion.

A polishing liquid was based on an aqueous solution of 3% by mass of HF containing 1.0 mol/L of KCl. To the polishing liquid, 50 mg/L of a surfactant that was a comparison object was added. The amount of the polishing liquid was 40 ml and the liquid temperature was maintained to 20° C.

As a glass substrate, aluminoborosilicate glass of 20 mm×20 mm with a thickness of 1 mm was used. The entire surface of the glass substrate was artificially scratched in advance so that the deposits 12 and 14 (see FIG. 1) were easily attached by polishing. The glass substrate was polished with each polishing liquid for 30 minutes.

As a control, a case (control) where the scratched glass was polished with a polishing liquid containing no surfactant was prepared.

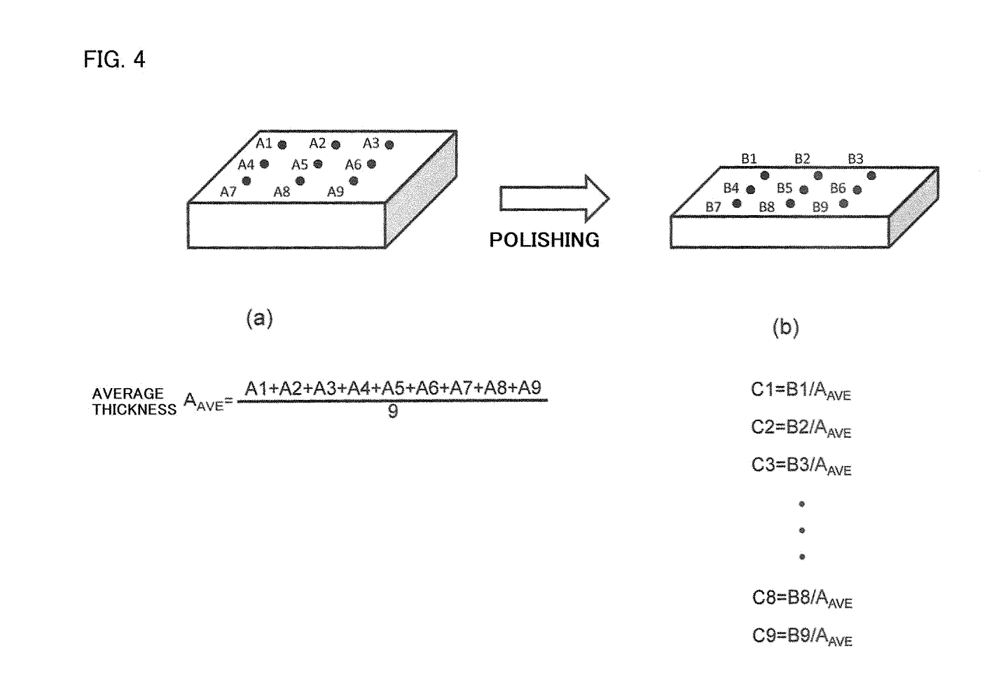

FIG. 4 illustrates a method for measuring the thickness of the glass substrate. With reference to FIG. 4, the thicknesses of the glass substrate at nine points were measured in advance (FIG. 4 (a)), and they are assigned as A1 to A9. The average of the thicknesses (A_{AVE}.) was considered as an average thickness of the glass substrate. The thicknesses at the same nine points were measured after polishing (these are assigned as B1 to B9). The polishing amount at each of the nine points was determined by subtracting the thickness at each of the nine points (B1 to B9) from the average thickness (A_{AVE}.) (these are assigned as C1 to C9).

Glass polishing amounts (C1 to C9) in a case of using each polishing liquid containing each surfactant were subjected to a significant difference test relative to the glass polishing amounts (C1 to C9) of the control. Thus, the presence or absence of significance was determined.

Hereinafter, samples will be described.

(Sample 1)

Sodium polyoxyethylene alkyl ether phosphate was used as a surfactant. This surfactant is referred to as a phosphate ester-type surfactant. Sample 1 contains no sulfonic acid group.

(Sample 2)

Polyacrylic acid (average molecular weight: 6,000) was used as a surfactant. This surfactant is referred to as a carboxylic acid-type surfactant because the polyacrylic acid contains a carboxylic acid at its terminal. Sample 2 contains no sulfonic acid group.

(Sample 3)

Sodium polyoxyethylene alkyl ether sulfate was used as a surfactant. This surfactant is a sulfate-type surfactant. Sample 3 contains a sulfonic acid ester group.

(Sample 4)

Sodium dodecyl sulfate was used as a surfactant. This surfactant is a sulfate-type surfactant. Sample 4 contains a sulfonic acid ester group.

(Sample 5)

Sodium linear alkylbenzene sulfonate was used as a surfactant. This surfactant is a sulfonic acid-type surfactant. Sample 5 contains a sulfonic acid group.

(Sample 6)

Sodium alkyl (branched chain) benzene sulfonate was used as a surfactant. This surfactant is a sulfonic acid-type surfactant. Sample 6 contains a sulfonic acid group.

(Sample 7)

Sodium alkylnaphthalene sulfonate was used as a surfactant. This surfactant is a sulfonic acid-type surfactant. Sample 7 contains a sulfonic acid group.

(Sample 8)

Naphthalene sulfonic acid formalin condensate sodium salt was used as a surfactant. This surfactant is a sulfonic acid-type surfactant. Sample 8 contains a sulfonic acid group.

(Sample 9)

Sodium dialkyl sulfosuccinate was used as a surfactant. This surfactant is a sulfonic acid-type surfactant. Sample 9 contains a sulfonic acid group.

(Sample 10)

Disodium monoalkyl sulfosuccinate was used as a surfactant. This surfactant is a sulfonic acid-type surfactant. Sample 10 contains a sulfonic acid group.

(Sample 11)

Disodium polyoxyethylene alkyl sulfosuccinate was used as a surfactant. This surfactant is a sulfonic acid-type surfactant. Sample 11 contains a sulfonic acid group.

(Sample 12)

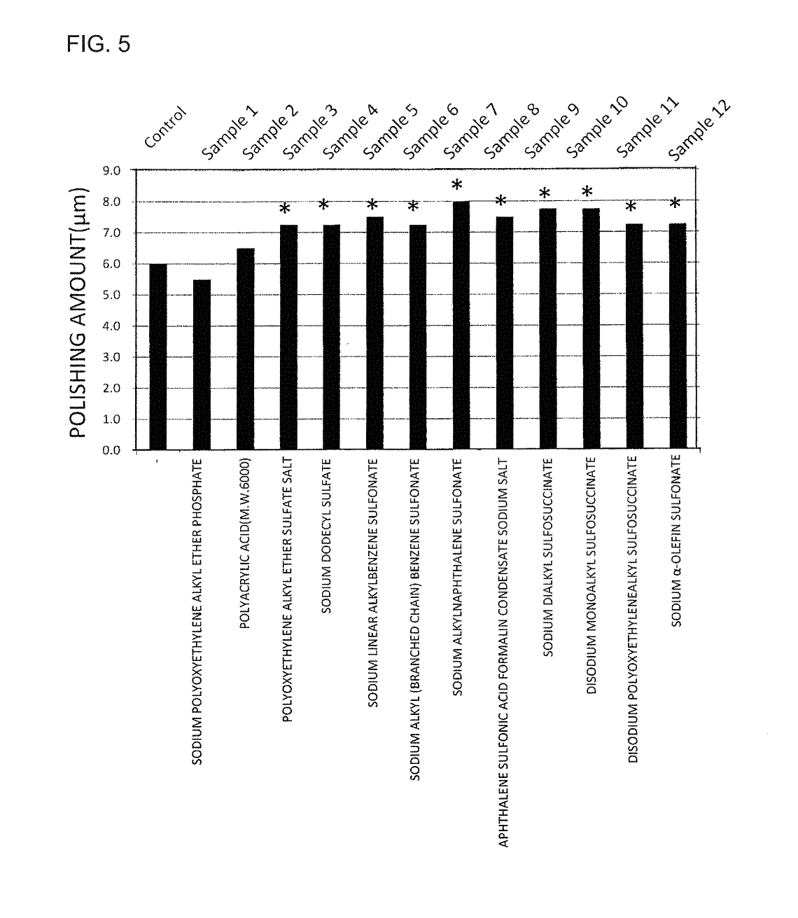

Sodium α-olefin sulfonate was used as a surfactant. This surfactant is a sulfonic acid-type surfactant. Sample 12 contains a sulfonic acid group. The surfactants of respective Samples are collectively shown in Table 1 and the measurement results are shown in FIG. 5.

TABLE 1

| NO. | GROUP | COMPOUND NAME |
|---|---|---|
| CONTROL | — | — |
| (WITH | | |
| SCRATCH) | | |
| 1 | PHOSPHATE- | SODIUM POLYOXYETHYLENE |
| | TYPE | ALKYL ETHER PHOSPHATE |
| 2 | CARBOXYLIC | POLYACRYLIC ACID(M.W. 6000) |
| | ACID-TYPE | |
| 3 | SULFATE- | SODIUM POLYOXYETHYLENE |
| | TYPE | ALKYL ETHER SULFATE |
| 4 | SULFATE- | SODIUM DODECYL SULFATE |
| | TYPE | |
| 5 | SULFONIC | SODIUM LINEAR ALKYLBENZENE |
| | ACID-TYPE | SULFONATE |
| 6 | SULFONIC | SODIUM ALKYL (BRANCHED |
| | ACID-TYPE | CHAIN) BENZENE SULFONATE |
| 7 | SULFONIC | SODIUM ALKYLNAPHTHALENE |
| | ACID-TYPE | SULFONATE |
| 8 | SULFONIC | NAPHTHALENE SULFONIC ACID |
| | ACID-TYPE | FORMALIN CONDENSATE SODIUM |
| | | SALT |
| 9 | SULFONIC | SODIUM DIALKYL SULFO- |
| | ACID-TYPE | SUCCINATE |
| 10 | SULFONIC | DISODIUM MONOALKYL SULFO- |
| | ACID-TYPE | SUCCINATE |
| 11 | SULFONIC | DISODIUM POLYOXYETHYLENE- |
| | ACID-TYPE | ALKYL SULFOSUCCINATE |
| 12 | SULFONIC | SODIUM α-OLEFIN SULFONATE |
| | ACID-TYPE | |

In Table 1, “No.” represents sample number. “Group” represents a group of surfactant. “Compound name” represents a surfactant used in fact.

With reference to FIG. 5, the horizontal axis is each sample. Under the horizontal axis, the type of surfactant is described. Above the horizontal axis, the sample number is described. The vertical axis is the polishing amount (μm).

The “polishing amount” of each sample was compared with that of the control, and whether the difference was a significant difference was examined on the basis of significant level of 0.05. The sample in which the difference was determined as a significant difference was marked with an asterisk. For example, the polishing amount in Sample 1 was smaller than that of the control. The polishing amount in Sample 2 was larger than that of the control. However, these differences were not considered as a significant difference.

On the other hand, the polishing amounts in Samples 3 to 12 were larger than that of the control. The differences in polishing amount between Samples 3 to 12 and the control were judged to be a significant difference by the significant difference test.

From the results of FIG. 5, both the sulfate-type surfactant having a sulfonic acid ester group (Samples 3 and 4) and the sulfonic acid-type surfactant having a sulfonic acid group (Samples 5 to 12) had a significant difference relative to the control containing no surfactant. In other words, although duration for polishing treatment was the same for all samples, it was observed that polishing amounts for these samples were larger than that of the control. It is considered that because the amount of the formed gentle undulation 20 shown in FIG. 3 is small, the polishing amount observed is large. Therefore, it can be said that the polishing liquids containing these surfactants exhibit an effect of remedy (suppressing) roughening of the surface as compared with the polishing liquid containing no surfactant.

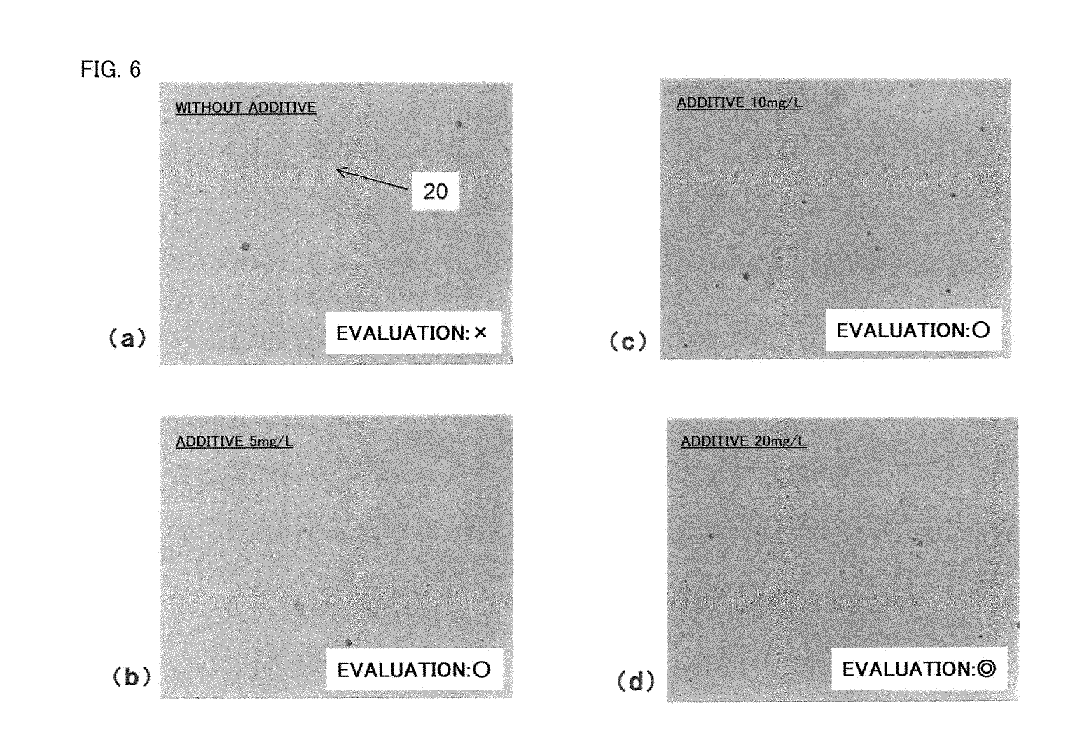

FIG. 6 is a photograph of a glass surface that was subjected to pre-polishing with the polishing liquid containing each of these surfactants, followed by main polishing. Evaluation shown in each photograph is visual evaluation, which is rough evaluation. A polishing liquid was based on a solution of 3% by mass of hydrofluoric acid containing 1.0 mol/L of KCl. To the solution, the surfactant was added and the effect thereof was confirmed. This basic polishing liquid contained an alkali metal. Therefore, when the polishing liquid does not contain a surfactant, a surface is roughened. The size of glass was 50 mm×50 mm and the thickness thereof was 1.2 mm. The liquid temperature was 40° C. and the liquid amount was 800 mL. The polishing amount in pre-polishing was 15 μm (one side) per the glass.

When a white roughened surface in a crack pattern that can be discriminated as roughening of the surface could be confirmed in a visual field of the photograph, the surfactant was evaluated to be poor (x). When roughening of a surface could be confirmed only by changing the visual field and searching the roughened surface, the surfactant was evaluated to be good (O). When roughening of a surface could hardly be confirmed even by changing the visual field, the surfactant was evaluated to be excellent (⊚). The good (O) and excellent (⊚) evaluations mean a quality in which an actual product has no problem.

FIG. 6(a) illustrates a case where a surfactant was not contained. In the case where a surfactant was not contained (FIG. 6(a)), a white crack pattern that can be recognized as roughening of a surface was observed. When pre-polishing was performed with the polishing liquid containing 5 mg/L of a surfactant, the roughening of the surface was significantly improved (FIG. 6(b)). In a case where the addition amount of the surfactant was 10 mg/L, the roughening of the surface was found only by changing the visual field and searching the roughened surface (FIG. 6(c)). In a case where the addition amount of the surfactant was 20 mg/L, the roughening of the surface could hardly be found (FIG. 6(d)). This configuration sufficiently reflects suggestion of the results shown in FIG. 5.

When 5 mg/L or more of the polishing liquid according to the present invention is used as described above, roughening of a surface after main polishing can be suppressed, and a glass surface of high grade can be obtained. The surfactant acts to suppress the roughening of the surface. Therefore, even by addition of the surfactant in an amount equal to more than a certain amount, a further effect cannot be expected. The present inventors confirmed that the effect was saturated by 50 mg/L of the surfactant added and the effect is not changed even by addition of a larger amount of the surfactant to the polishing liquid. The aforementioned results were confirmed also in the case where, when Na was used as an alkali metal, the same evaluation as that in FIG. 6 was obtained.

### INDUSTRIAL APPLICABILITY

The polishing liquid according to the present invention can be suitably used for polishing treatment on glass.

### REFERENCE SIGNS LIST

10 scratch
12 deposit
14 deposit
16 convex undulation
18 crater-shape protrusion
20 gentle undulation
22 annular rim
24 basin
26 crack pattern
St polishing amount

1. A polishing liquid for glass comprising hydrofluoric acid, an alkali metal, water, and a surfactant, wherein
the surfactant includes at least one of an alkane sulfonic acid salt, an alkyl amide sulfonic acid salt, an alkyl ether sulfosuccinic acid salt, an alkyl diphenyl ether disulfonic acid salt, an alkylene disulfonic acid salt, a phenol sulfonic acid salt, a polyoxyethylene alkyl ether sulfosuccinic acid salt, a polyoxyethylene alkyl sulfosuccinic acid disalt, a polystyrene sulfonic acid salt, a monoalkyl sulfosuccinic acid salt, a monoalkyl sulfosuccinic acid disalt, an alkylnaphthalene sulfonic acid salt, a dialkylsulfosuccinic acid salt, a fatty acid alkylol alkylbenzene sulfonic acid salt, an N-acyl taurine acid salt, a naphthalene sulfonic acid formalin condensate salt, an α-olefin sulfonic acid salt, an α-sulfo fatty acid ester salt, an alkyl ether sulfuric acid salt, an alkenyl sulfuric acid ester salt, an alkyl polyoxyethylene sulfuric acid salt, a polyoxyethylene alkyl aryl sulfuric acid ester salt, a polyoxyethylene alkyl ether sulfuric acid ester salt, a polyoxyethylene alkyl phenyl ether sulfuric acid ester salt, an oil-and-fat sulfuric acid ester salt, a higher alkyl ether sulfuric acid ester salt, and a higher alcohol sulfuric acid ester salt.

2. The polishing liquid for glass according to claim 1, wherein the alkali metal is potassium.

3. (canceled)

4. (canceled)

5. (canceled)

6. A method of polishing glass comprising:
treating a substance to be treated having a glass surface with a polishing liquid containing hydrofluoric acid, an alkali metal, water, and a surfactant; and
treating the substance with the polishing liquid containing hydrofluoric acid and water, wherein:
the surfactant includes at least one of an alkane sulfonic acid salt, an alkyl amide sulfonic acid salt, an alkyl ether sulfosuccinic acid salt, an alkyl diphenyl ether disulfonic acid salt, an alkylene disulfonic acid salt, a phenol sulfonic acid salt, a polyoxyethylene alkyl ether sulfosuccinic acid salt, a polyoxyethylene alkyl sulfosuccinic acid disalt, a polystyrene sulfonic acid salt, a monoalkyl sulfosuccinic acid salt, a monoalkyl sulfosuccinic acid disalt, an alkylnaphthalene sulfonic acid salt, a dialkylsulfosuccinic acid salt, a fatty acid alkylol alkylbenzene sulfonic acid salt, an N-acyl taurine acid salt, a naphthalene sulfonic acid formalin condensate salt, an α-olefin sulfonic acid salt, an α-sulfo fatty acid ester salt, an alkyl ether sulfuric acid salt, an alkenyl sulfuric acid ester salt, an alkyl polyoxyethylene sulfuric acid salt, a polyoxyethylene alkyl aryl sulfuric acid ester salt, a polyoxyethylene alkyl ether sulfuric acid ester salt, a polyoxyethylene alkyl phenyl ether sulfuric acid ester salt, an oil-and-fat sulfuric acid ester salt, a higher alkyl ether sulfuric acid ester salt, and a higher alcohol sulfuric acid ester salt.

7. The method of polishing glass according to claim 6, wherein the alkali metal is potassium.
